(19) United States
(12) Patent Application Publication
(10) Pub. No.: US 2025/0246976 A1
(43) Pub. Date: Jul. 31, 2025

(54) ELECTRICAL MOTOR ASSEMBLY WITH A MOTOR CABLE AND A METHOD FOR IDENTIFYING A MOTOR CABLE IN AN ELECTRICAL MOTOR ASSEMBLY

(71) Applicant: B&R Industrial Automation GmbH, Eggelsberg (AT)

(72) Inventors: Martin Schalk, Neumarkt am Wallersee (AT); Stefan Pointner, Weng im Innkreis (AT)

(21) Appl. No.: 18/982,148

(22) Filed: Dec. 16, 2024

(30) Foreign Application Priority Data
Jan. 31, 2024 (EP) 24155115.9

(51) Int. Cl. H02K 11/33

(52) U.S. Cl. CPC H02K 11/33

(57) ABSTRACT

In order to identify the properties of a cable connecting an inverter with an electrical load, a gate drive circuit to switch at least on semiconductor switch in the inverter is designed to, at an excitation time point, set an electrical gate quantity to an identification gate quantity value generating an identification output voltage on the output of the inverter to be fed to the cable, at an at least one detection time point after the excitation time point, measure at least one measured value of at least one electrical cable quantity, at an identification time point after the detection time point, identify at least one cable parameter of the cable from the least one measured value and the identification gate quantity value.

### CROSS-REFERENCE TO RELATED APPLICATIONS

The present application claims priority to European Patent Application No. 24155115.9 filed on Jan. 31, 2024, and titled “ELECTRICAL MOTOR ASSEMBLY WITH A MOTOR CABLE AND A METHOD FOR IDENTIFYING A MOTOR CABLE IN AN ELECTRICAL MOTOR ASSEMBLY”, which is hereby incorporated by reference in its entirety.

### TECHNICAL FIELD

The present disclosure pertains to an electrical motor assembly comprising an inverter and a cable, the inverter having at least one semiconductor switch and a gate drive circuit, the gate drive circuit being designed to drive, in an alternating fashion, an electrical gate quantity present at a gate electrode of said semiconductor switch of the inverter between a maximum gate quantity value and a minimum gate quantity value, in order to switch the semiconductor switch to connect and/or disconnect a supply voltage to an output of the inverter for electrically supplying a load connected to the output through the cable. Further, the present disclosure pertains to a method for identifying a motor cable in an electrical motor assembly.

### BACKGROUND

In the design of modern power converters, much attention is paid to power conversion efficiency, power density, and system cost. Recently, also reliability of power electronic systems has been gaining increased attention, especially for systems with long operating hours in harsh environments.

Another aspect in today's power electronics to receive growing attention is the steady in-crease of switching frequencies. In this regard, significant progress has been made recently, bringing about new technologies, such as the so-called wide bandgap switches (“WBGs”), allowing for fast switching capabilities up to 10V/ns and higher, especially when compared to classical switching materials and/or classical switching technology. Unfortunately, high switching speeds are still accompanied by adverse effects, in the case of WBGs, but even more so in the case of “classical” semiconductors, such as classical insulated-gate bipolar transistors (IGBTs), classical metal-oxide-semiconductor field-effect transistor (“MOSFET”), etc. Said adverse effects range from voltage overshoot and/or voltage ringing between drain and source of a switch, as well as to deteriorated electromagnetic interference properties (EMC).

These issues are known in the prior art, cf., US 2019/0074827 A1, U.S. Pat. No. 11,316,513 B2 or GB 2589296 A. Also in scientific literature, issues related to high-speed switching of semiconductor switches, particularly IGBT-switches, have been covered at length.

“A four-step control for IGBT switching improvement using an active voltage gate driver”, Chen Li et al., Wiley, IET Power Electronics, 2021, for instance, discloses a driving circuit and a corresponding method for switching an IGBT-switch, providing a step-wise modification of a gate-source voltage in the course of changing said gate-source voltage from a minimum to a maximum value for switching the IGBT, aiming at reduced overshoot of the gate-source voltage.

“A Voltage Controlled Current Source Gate Drive Method for IGBT Devices”, Lu Shu et al., IEEE, 2014, discloses a similar concept, where different modification approaches for the gate-source voltage are suggested, depending on whether the gate-source voltage is changed from a minimum to a maximum value or vice versa.

Even though the above-referenced prior art discloses highly elaborate concepts targeted at improving the performance of semiconductor switches at high switching frequencies, it turns out that these concepts especially lack the ability to take into account components surrounding the given semiconductor switches. This was found to be particularly true for the assembly mentioned at the outset, consisting of an inverter, an electrical load and a cable to connect the inverter with the electrical load. If, in such a case, the inverter comprises semiconductor switches that are switched in a high-speed fashion, the electrical quantities present in and at a switch are particularly influenced by the electrical properties of the connecting cable. For that reason, connecting cables, but also electrical loads supplied by the inverter oftentimes magnify the adverse effects mentioned above, i.e., voltage overshoot and/or voltage ringing between drain and source of a switch. These dependencies have not yet been considered in operating strategies for inverters and switches known from the prior art.

Against this background, it is an object of the present disclosure to provide an improved gate drive circuit, particularly allowing to incorporate information on the components surrounding the gate drive circuit and switches driven by the gate drive circuit. In the scope of the present disclosure, the term “gate drive circuit” is to be construed broadly, representing generally an electrical circuit capable of switching a semiconductor switch, e.g., BJTs or IGBTs or FETs, which are, e.g., known to have different pins (BCE, GCE, GDS, respectively).

### BRIEF DESCRIPTION

This object, for the assembly mentioned at the outset, is achieved in that the gate drive circuit is designed to set the electrical gate quantity to an identification gate quantity value generating an identification output voltage on the output of the inverter to be fed to the cable at an excitation time point, measure at least one measured value of at least one electrical cable quantity, at an at least one detection time point after the excitation time point, and, identify at least one cable parameter of the cable from the least one measured value and the identification gate quantity value at an identification time point after the detection time point.

By directly using one of the electrical gate quantities present at the at least one semiconductor switch, a particularly efficient way of identification becomes possible, which, in addition, also allows to monitor the impact of the cable on the electrical situation in and around the switch. In methods known from the prior art, typically at least two electrical quantities in a cable have to measured, e.g. an electrical cable current and an electrical cable voltage, to be able to carry out an identification. Clearly, this requirement complicates the hardware setup, as at least two kits of measuring equipment have to be provided. In this regard, the present disclosure allows for a simplification and reduction of cost and component outlay. Additionally, due to the fact that electrical quantities present directly at the switch are being used for cable identification, also the interaction between the cable and the semiconductor switch itself can be identified easily, and hence be taken into account, e.g., into an operating strategy of the inverter. This information benefit turns out as a significant advantage in many scenarios.

Another important advantage of the present disclosure is that the identification method may be carried out by a gate drive circuit itself. Hence, no additional measuring and/or data acquisition and/or processing equipment is needed.

Further, the aforementioned object is achieved by a method for identifying a motor cable in an electrical motor assembly comprising an inverter and a cable, the inverter having at least one semiconductor switch and a gate drive circuit, the gate drive circuit being designed to drive, in an alternating fashion, an electrical gate quantity present at a gate electrode of said semiconductor switch of the inverter between a maximum gate quantity value and a minimum gate quantity value to switch the semiconductor switch in order to connect and/or disconnect a supply voltage to an output of the inverter for electrically supplying a load connected to the output through the cable, comprising the steps of, at an excitation time point, setting the electrical gate quantity to an identification gate quantity value generating an identification output voltage on the output of the inverter to be fed to the cable, at at least one detection time point after the excitation time point, measuring at least one measured value of at least one electrical cable quantity, at an identification time point after the detection time point, identifying at least one cable parameter of the cable from the least one measured value and the identification gate quantity value.

### BRIEF DESCRIPTION OF DRAWINGS

The present disclosure is described in greater detail below with reference to FIGS. 1 to 5, which show schematic and non-limiting advantageous embodiments of the present disclosure by way of example. The specific examples described herein are only used to explain the content of the present disclosure and are not intended to limit the present embodiment. The following are shown:

FIG. 1 an arrangement of a gate driver circuit, an inverter, a cable, and an electrical load;

FIG. 2 a close-up of an excitation and measurement signal used for cable identification;

FIGS. 3a, 3b, 3c, 3d possible signals occurring for different cable lengths;

FIG. 4 an application of the present disclosure in a three-phase system; and

FIGS. 5a, 5b possible profiles of the turn on behavior of an IGBT collector-emitter voltage.

### DETAILED DESCRIPTION

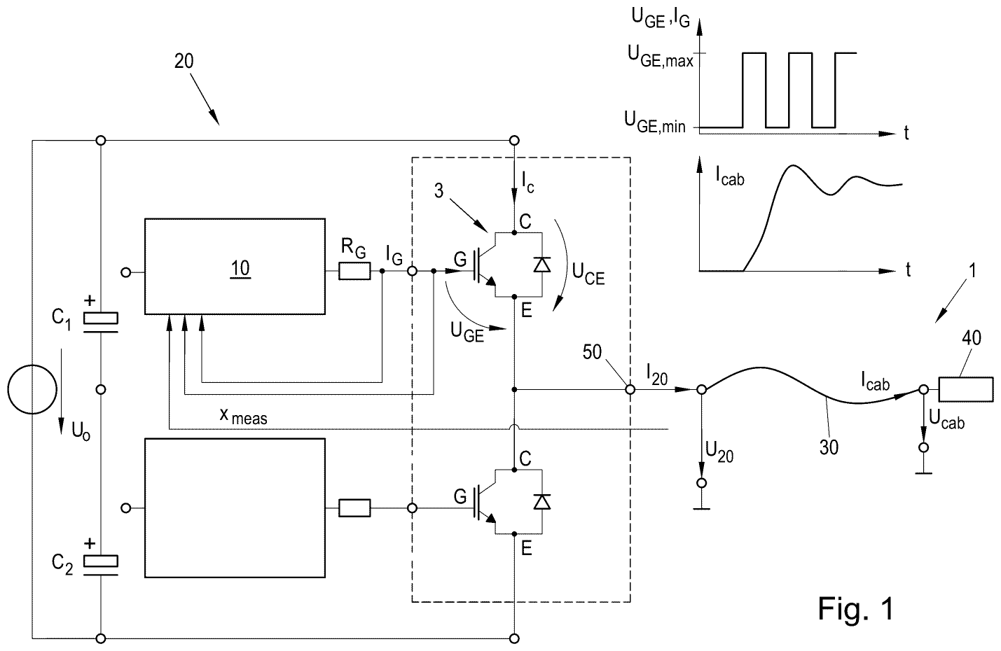

FIG. 1 shows an assembly of a gate driver circuit 10, an inverter 20 comprising two semiconductor (power-)switches 3, a cable 30, an electrical load 40, an electrical source voltage U₀, and input capacitors C₁, C₂. Each semiconductor switch 3 has a gate electrode G, a collector electrode C, and an emitter electrode E. Such circuits and possible ways to operate such a circuit are known from the prior art, cf., e.g., U.S. Pat. No. 9,444,448 B2.

The purpose of the gate drive circuit 10 is to drive an electrical gate quantity U_{GE}, I_{G} present at a gate electrode G of the semiconductor switch 3 of the inverter 20, in order to switch the semiconductor switch 3 to eventually drive an electrical output current I₂₀ and/or an electrical output voltage U₂₀ of the inverter 20 through the cable 30 to supply the load 40. To that end, the gate drive circuit 10 comprises operating means (not shown) designed to, during operation of the inverter 20, alternate said electrical gate quantity U_{GE}, I_{G} between a maximum gate quantity value U_{GE,max}, I_{G,max} and a minimum gate quantity value U_{GE,min}, I_{G,min} to switch the semiconductor switch 3, as is well-known in the prior art.

Said operating means are well-known from the prior art as well, and may themselves comprise semiconductor switches and, e.g., a control unit, to provide one or more control signals for switching semiconductor switches 3 as those shown in FIG. 1. Within the scope of the present disclosure, the semiconductor switches 3 are by no means restricted to a specific kind of semiconductor switch, and may be implemented in the form of an insulated-gate bipolar transistor IGBT, a bipolar junction transistor BJT, or a field-effect transistor FET.

In some embodiments, said electrical gate quantity U_{GE}, I_{G} is an electrical voltage dropping from said gate electrode G to said emitter electrode E, or an electrical current flowing to or from the gate electrode G. By alternating the electrical gate quantity U_{GE}, I_{G} between a maximum gate quantity value U_{GE,max}, I_{G,max} and a minimum gate quantity value U_{GE,min}, I_{G,min} (positive gate emitter voltages are typically applied to switch on a switch 3, while negative gate emitter voltages are applied to switch it off), several well-known operating methods, such as pulse-width modulation (PWM), pulse-frequency modulation (PFM), etc., may be implemented, with the aim of generating a pulsed electrical output current I₂₀ and/or a pulsed electrical output voltage U₂₀ having a pre-defined current-time-area or voltage-time-area in a pre-defined time interval, respectively. As the fundamentals of operating an electric circuit like the one shown in FIG. 1, especially with regards to implementing methods as PWM, PFM etc., are well-known in the prior art, e.g., from US 2019/0074827 A1, U.S. Pat. No. 11,316,513 B2 or GB 2589296 A, further details in this respect are spared at this point.

As mentioned earlier, concepts known from the prior art specifically lack the ability to take into account the effect and the impact of surrounding components on a semiconductor switch 3 like those shown in FIG. 1. In order to overcome this deficiency, in the present disclosure, it is provided that the gate drive circuit 10 is designed to set the electrical gate quantity U_{GE}, I_{G} to an identification gate quantity value U_{GE,I}, I_{G,I} generating an identification output voltage U₂₀ on the output 50 of the inverter 20 to be fed to the cable 30 at an excitation time point t_{E}, measure at least one measured value xₘₑₐₛ of at least one electrical cable quantity x_{cable}, at an at least one detection time point t_{D} after the excitation time point t_{E}, and, identify at least one cable parameter Z_{cab} of the cable 30 from the least one measured value xₘₑₐₛ and the identification gate quantity value U_{GE,I}, I_{G,I} at an identification time point ti after the detection time point t_{D}.

By directly using one of the electrical gate quantities present at the at least one semiconductor switch 3, a particularly efficient way of identification becomes possible, which, in addition, also allows to monitor the impact of the cable 30 on the electrical situation at and in the switch 3. In methods known from the prior art, typically at least two electrical quantities in a cable have to measured, e.g. an electrical cable current I_{cable} and an electrical cable voltage U_{cable}, to be able to carry out an identification. Clearly, this requirement complicates the hardware setup, as at least two kits of measuring equipment have to be provided.

In some embodiments, the at least one cable parameter Z_{cab} to describe the cable may be selected from the group consisting of a cable length, a cable resistance, a cable inductance, a cable material, a cable cross section, a cable diameter, a cable capacity, and the at least one cable quantity x_{cable} may be selected from the group consisting of a cable current I_{cable}, a cable voltage U_{cable}, a cable temperature, a cable magnetic field. As will be discussed at length in the following, the present disclosure provides for flexibility in a broad range of aspects. One example of this flexibility is the ability to select a suitable cable parameter Z_{cable} from a broad range of parameters, depending on the specific needs of an operating strategy of an inverter 20 in which the cable parameter Z_{cable} is used. Obviously, also more than one of the aforementioned cable parameters may be identified and followingly used for operating the semiconductor switches 3 and hence the entire assembly.

It may as well be provided that more than just one pair of measured values is taken into account for the identification process. Hence, the gate drive circuit 10 may further be designed to, at a multiple of, in some embodiments consecutive, excitation time points t_{E,1}, t_{E,2}, . . . , set the electrical gate quantity U_{GE}, I_{G} to a corresponding identification gate quantity values U_{GE,I,1}, U_{GE,I,1}, . . . at each of said excitation time points t_{E,1}, t_{E,2}, . . . , to measure a multiple of measured values xₘₑₐₛ of the at least one electrical cable quantity x_{cable} at a multiple of detection time points t_{D,1}, t_{D,2}, . . . corresponding to said multiple of excitation time points t_{E,1}, t_{E,2}, . . . , and to identify the at least one cable parameter Z_{cab} of the cable 30 from the multiple of measured values xₘₑₐₛ and the multiple of identification gate quantity values U_{GE,I}, I_{G,I}. In some embodiments, the multiple of excitation time points t_{E,1}, t_{E,2}, . . . , are separated by a pre-defined, constant sampling time, as is usual and well-known in digital data processing. However, also different concepts are conceivable, such as modifying the sampling rate, such that high sampling rates are used during transient phases and low sampling rates are used when no identification is desired, in order to save resources of the control unit of the gate drive circuit, where the identification is carried out in some embodiments. Also, the time distances between an excitation time point t_{E,1}, a corresponding detection time point t_{D,1} and an identification time point ti may be different and may also be varied, from time distances as short as just one sampling interval to time distance much longer.

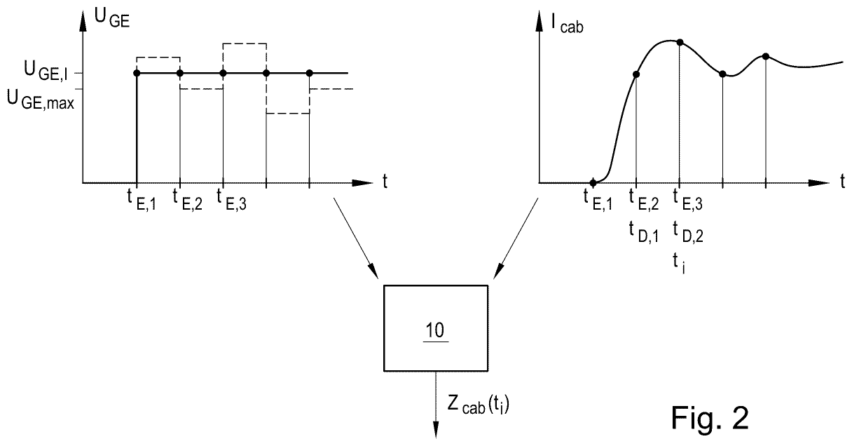

FIG. 2 shows an example of such an identification process, where a step response of a cable current I_{cable} is excited and then measured. The step response may be captured by two vectors comprising samples of the measured data from the gate voltage U_{GE} and the cable current I_{cable}. To eventually arrive at the desired cable parameters, a series of well-established methods are available from, e.g., digital signal processing and/or control engineering. For instance, a transfer function may be identified from the signals U_{GE,I}, I_{cab} shown in FIG. 1, whose gain represents an impedance, from which a cable parameter Z_{cab} may be calculated from. In scientific literature several monographies deal with the subject of deriving system models, like transfer functions or state space models etc., from which the desired cable parameters may be derived from, e.g., Lennart Ljung: System Identification: theory for the User. 2. Auflage. Prentice Hall, Upper Saddle River 2006, or Oliver Nelles: Nonlinear System Identification. 1. Auflage. Springer, 2000, or Rolf Isermann, Marco Münchhof: Identification of Dynamic Systems—An Introduction with Applications. 1. Auflage. Springer, 2010. Also models like a well-known ARMA model, or a (continuous or discrete) state space model may be identified in a first step, and the cable parameter may be derived from such model description. While these concepts are known in the prior art, they have not yet been applied to identifying a cable from a measured gate quantity from a semiconductor switch.

As can be seen from FIG. 2, the identification gate quantity values U_{GE,I}, I_{GE,I}, in the shown case the gate voltage U_{GE,I}, may be set to a value higher than the maximum gate quantity value U_{GE,max} used for switching in regular operation, or may as well be set to values lower than a regular maximum gate quantity value U_{GE,max}, but may also be set to the same value as the maximum gate quantity value U_{GE,max}, depending on the needs of a given situation. As explained below, it can also be beneficial to keep to the gate quantity constant for periods longer than a regular switching interval, in order to, e.g., identify a step response of a cable quantity. The same is true in the case of a current, where an identification gate current may be set to the current used for switching, or to a lower or higher value.

In the case shown in FIG. 2, exciting the cable 30 with a voltage step (impulse) causes a damped oscillation due to electro-magnetic energy storages present in the cable 30 (R, L, C). The measurable frequency and the damping of this oscillation depend, e.g., on the length and thus the primary line constants of the cable 30, which may eventually be calculated from the measured data so obtained. Since the impedance of the electrical load 40, e.g., the electrical load of a motor, typically is much larger than the impedance of the cable 30, the load 40 can, in most practically relevant cases, be ignored, especially in the presently relevant frequency range. However, there are use cases where an impedance of an electrical load 40 or an impedance of an electrical motor has to be taken into account specifically, because the cable impedance and the motor impedance may be of comparable value. Since a motor impedance typically is known a prior, e.g., from a data sheet, this is usually unproblematic. In such a case, a motor impedance may simply be subtracted from an identified impedance to arrive at a desired cable impedance, for example.

In the case shown in FIG. 2, the gate drive circuit 10 sets the multiple of corresponding identification gate quantity values U_{GE,I,1}, U_{GE,I,2}, . . . to the same value in order to excite and detect a step response of the of the at least one electrical cable quantity x_{cable}. However, it is of course also possible to set at least two of the multiple of corresponding identification gate quantity values U_{GE,I,1}, U_{GE,I,2}, . . . to values different from one another, in order to excite the cable 30 at an at least one pre-defined excitation frequency and to detect at least one frequency response of the at least one electrical cable quantity x_{cable} at said excitation frequency.

In a fashion similar to measuring more than just one instance/sample of an electrical gate quantity and an electrical cable quantity, it is also conceivable to measure more than just one electrical cable quantity I_{cab}, U_{cab}, and hence use more than just one cable quantity for cable identification. For instance, measuring an input voltage to the cable 30 supplied by the inverter and an output voltage supplied from the cable 30 to the load 40 may be measured. To that end, the gate drive circuit 10 may be designed to detect a further measured value of at least one further electrical cable quantity at the at least one detection time point t_{D}, and identify the at least one cable parameter Z_{cab} of the cable 30 from the least one measured value xₘₑₐₛ, the at least one further measured value x_{meas,2} and the identification gate quantity value U_{GE}, I_{G,I}. Also in this case, when more than two measured variables are used, several algorithms exist that may be employed. What is crucial, however, is that within the scope of the present disclosure, an electrical gate quantity is always used, in order to take into account the relation between gate and cable.

As an alternative to exciting and detecting a step response, several other approaches, also known from literature, may be used, e.g., frequency sweeps or chirp excitation or even random excitation signals may be used, as is indicated by the dashed line in FIG. 2.

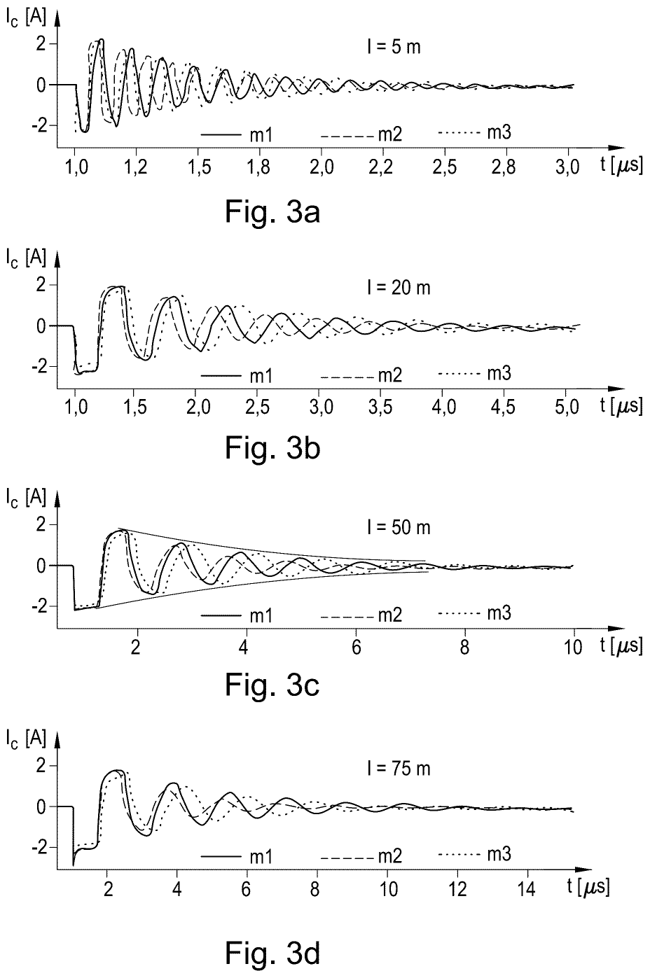

How different cable parameters Zₑₐb, but especially different cable lengths, influence measured signals of a cable current, is further shown in FIG. 3a-3d, where a series of measurements m1, m2, m3 is shown for cable lengths of 1=5 m (FIG. 3a), 1=20 m (FIG. 3b), 1=50 m (FIG. 3c) and 1=75 m (FIG. 3d). As can be seen from these results, the oscillation frequency of the shown current oscillations decreases with increasing cable lengths. Hence, the cable length as a cable parameter Z_{cab} may be computed from the frequency content contained in a measured cable-current signal, which provides a further option to carry out the present disclosure. To obtain the frequency content, methods like FFT, DFT, or other frequency identification methods may be employed.

As mentioned previously, the present disclosure provides great flexibility and hence allows for a series of different, advantageous embodiments. Some of those embodiments are explained hereafter. In a first embodiment, the gate drive circuit 10 may be designed to compare a value of the at least one cable parameter Z_{cab} to a pre-defined reference cable parameter value in order to diagnose the cable 30. An important option in this regard is to measure a set of different cable types and lengths in advance or extract this data from data sheets, save this data, e.g., in said control unit of the gate drive circuit, as comparison values (e.g. in the form of a look-up table) and check for consistency. In a further embodiment, in this context, the gate drive circuit 10 may be designed to stop the inverter 20 in case a deviation of the value of the at least one cable parameter Z_{cab} from the pre-defined reference cable parameter value exceeds or falls below a pre-defined deviation threshold.

In another embodiment, the gate drive circuit 10 may be designed to identify the at least one cable parameter Z_{cab} before a start of operation of the inverter 20. In this fashion, a cable identification procedure can initially be triggered automatically by the gate drive circuit 10 or by manual command. Before operation in the present context means before the inverter start supplying the load 40 via the cable, i.e., before an energy conversion process in the load is initiated, by, e.g., converting electrical energy into mechanical energy, as is the case in electrical machinery.

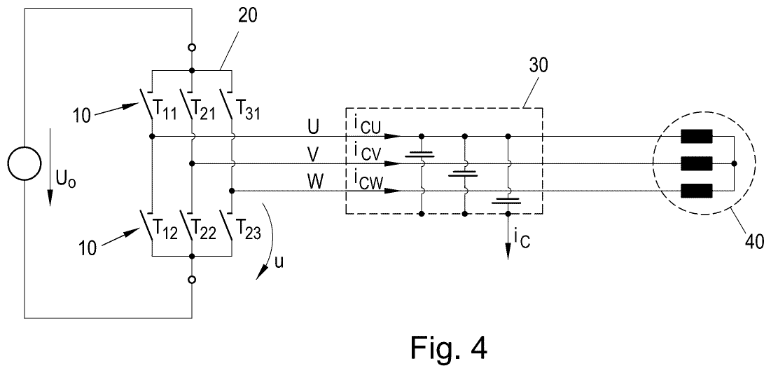

A further important use case of the present disclosure are three-phase systems, like the one shown in FIG. 4, which allows for a particularly advantageous embodiment of the present disclosure. Specifically, within the scope of the present disclosure, a so-called 0-PWM operation may be employed in this case, where the upper switches T11, T21, T31 are each switched simultaneously, and also the lower switches are all switched simultaneously. In this case, it was found that the voltages u being fed to the lines and the sum of the capacitive currents i_{C}=i_{CU}+i_{CV}+i_{CW} present in the three phases U,V,W are related by the equation

$${i}_{C} = ( {C}_{U} + {C}_{V} + {C}_{W} ) \cdot \frac{du}{dt}$$

out of which for instance the cable capacitances may be computed easily.

An additional benefit when using PWM is that by the means of constant PWM operation, a ripple DC current in the cable phases U, V, W is achieved. In this scenario, the current is primarily dependent on the switching frequency, the inductance and the DC resistance of the overall system, consisting of cable and motor. In addition to the cable, the current will be set primarily on the basis of the motor parameters that dominate in the low-frequency range. As the motor parameters must be known in order to operate the system, it is possible to determine the cable parameters by measuring the ripple current accordingly.

The identification process according to the present disclosure can be used in any classic electrical motor assembly (“drive system”), consisting of an inverter (“drive”), a motor cable and a motor. Precise knowledge about the connecting cable enables a series of advantageous functionalities, of which some are mentioned in the following. If the switching behavior of the inverter can be changed during operation, it can be optimized for the specific application (EMC emissions, switching losses, compliance with the dv/dt load on the motor), based on information about the cable. This allows the efficiency of the entire system to be increased and the service life of the individual components (e.g. motor) to be extended. Further, diagnosis of whether a permissible motor cable is connected can be carried out, and, if necessary, a warning or error (e.g. cable too long/cross-section too small) may be output, in case a wrong component, i.e., a wrong cable or a wrong motor are in fact connected. By identifying the cable parameters and length, it can be ensured that operation only takes place with cables approved for the application or that the operation of the entire system can be optimized in terms of efficiency if the switching behavior of the drive can be changed during operation.

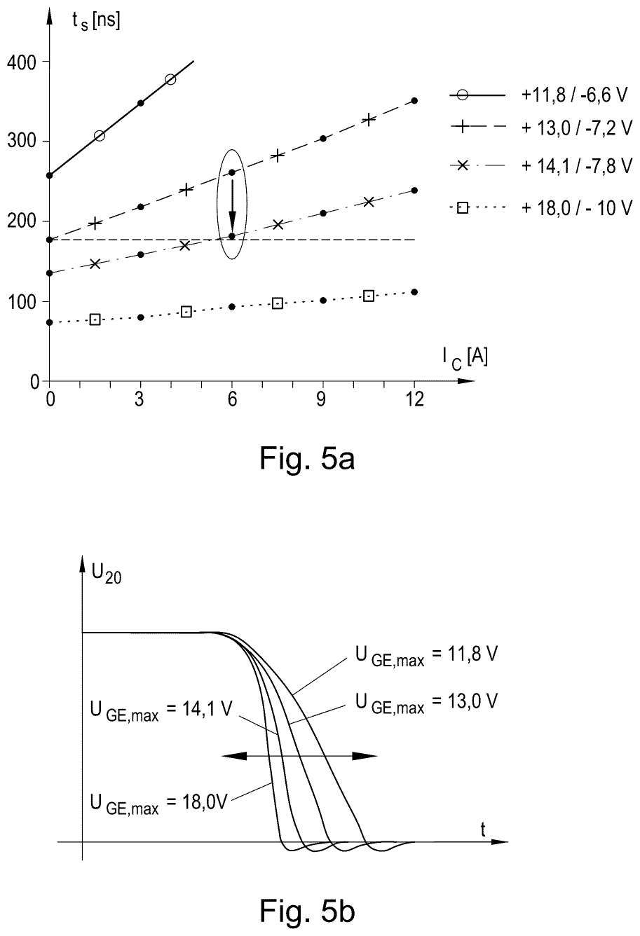

How the information on a cable gathered in the course of the present disclosure may eventually be used to modify the operating strategy of the gate drive circuit will be discussed below by means of FIGS. 5a, 5b. In the course of the present disclosure, it was found that especially the properties of the cable 30 have a crucial impact on the performance metrics of a gate drive circuit 10, such as (power) losses, EMC, dynamical and transient behavior of output quantities like U₂₀ and/or I₂₀, etc., as will be explained in the following, on the basis of FIGS. 5a and 5b.

To that end, FIG. 5a presents possible switching times t_{S} of a semiconductor switch 3, in the case shown the switching times of an IGBT, as a function of the collector current I_{C}. To a significant part, the collector current I_{C} depends on the effective impedance of a cable 30. It was found that the time t_{S} it takes to switch the semiconductor switch 3, i.e., to complete the transition from entirely closed to entirely open, varies with the collector current I_{C} drawn from the semiconductor switch 3, and hence with the cable impedance that impacts the collector current. Varying switching times t_{S}, however, are problematic, for several reasons. On the one hand, large switching times and thus slow switching, for obvious reasons, increases switching losses, already because the switching processes takes longer, leading to longer periods of time where both the current flowing through the switch as well as the voltage dropping over the switch are unequal zero. On the other hand, small switching times and thus high switching speeds lead to fast changes of the involved electrical quantities, leading to increased electromechanical radiation and thus worsened EMC properties. It is thus important to select an optimized switching time t_{S} for a given application and hence a given cable 30.

FIG. 5b, on the contrary, shows time profiles of an output voltage U₂₀ produced by an inverter 20 as shown in FIG. 1, for different maximum values of the gate-emitter voltage U_{GE}. With a higher voltage, the gate charge required to switch the semiconductor switch 3, in this case an IGBT, is applied more quickly, thus reducing the switching time t_{S}. For the switching process, it can thus be stated that switching times t_{S} can be reduced when larger gate-emitter voltages U_{GE} are being employed.

Combining the findings presented in FIGS. 5a and 5b, one may conclude that a change in switching speed due to a changed collector current I_{C} may be compensated by adjusting the gate supply and hence the gate-emitter voltages U_{GE}. An increase in switching times at higher operating currents I_{C} can hence be compensated for by adjusting U_{GE} based on information on the connecting cable 30, in order to maintain an optimized switching time t_{S}.

Specifically, to that end, the gate drive circuit 10 may be designed to, at an adjustment time point during operation of the inverter 20 after the identification time point ti, adjust said maximum gate quantity value U_{GE,max}, I_{G,max} to an adjusted maximum gate quantity value U_{max,A}, I_{max,A} depending on the at least one identified cable parameter Z_{cab}, to further alternate said electrical gate quantity U_{GE}, I_{G} between said adjusted maximum gate quantity value U_{max,A}, I_{max,A} and said minimum gate quantity value U_{GE,min}, I_{G,min} to switch the semiconductor switch 3. In a further embodiment, the maximum gate quantity value U_{GE,max}, I_{G,max} is pre-set before a start of operation of the inverter 20 and adjusted to said adjusted maximum gate quantity value U_{max,A}, I_{max,A} depending on the at least one identified cable parameter Z_{cab} during operation of the inverter 20 at the adjustment time point t_{A}. In a further embodiment, the gate drive circuit 10 comprises operating means for switching the semiconductor switch 3 and detecting means 11 for measuring the at least one measured value xₘₑₐₛ of the at least one electrical cable quantity x_{cable}.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An assembly comprising an inverter and a cable, the inverter having at least one semiconductor switch and a gate drive circuit, the gate drive circuit configured to drive, in an alternating fashion, an electrical gate quantity present at a gate electrode of the semiconductor switch of the inverter between a maximum gate quantity value and a minimum gate quantity value to switch the semiconductor switch in order to connect and/or disconnect a supply voltage to an output of the inverter for electrically supplying a load connected to the output through the cable, wherein the gate drive circuit is further configured to;
at an excitation time point, set the electrical gate quantity to an identification gate quantity value generating an identification output voltage on the output of the inverter to be fed to the cable;
at an at least one detection time point after the excitation time point, measure at least one measured value of at least one electrical cable quantity; and
at an identification time point after the detection time point, identify at least one cable parameter of the cable from the least one measured value and the identification gate quantity value.

2. The assembly according to claim 1, wherein the at least one cable parameter is selected from the group consisting of a cable length, a cable resistance, a cable inductance, a cable material, a cable cross section, a cable diameter, a cable capacity, and in that the at least one cable quantity is selected from the group consisting of a cable current, a cable voltage, a cable temperature, a cable magnetic field.

3. The assembly according to claim 1, wherein the gate drive circuit is further configured to, at a multiple of excitation time points, set the electrical gate quantity to corresponding identification gate quantity values at each of the excitation time points to measure a multiple of measured values of the at least one electrical cable quantity at a multiple of detection time points corresponding to the multiple of excitation time points, and to identify the at least one cable parameter of the cable from the multiple of measured values and the multiple of identification gate quantity values.

4. The assembly according to claim 3, wherein the gate drive circuit is further configured to set the multiple of corresponding identification gate quantity values to the same value in order to detect a step response of the of the at least one electrical cable quantity.

5. The assembly according to claim 3, wherein the gate drive circuit is further configured to set at least two of the multiple of corresponding identification gate quantity values to values different from one another, in order to excite the cable at an at least one pre-defined excitation frequency and to detect at least one frequency response of the of the at least one electrical cable quantity at the excitation frequency.

6. The assembly according to claim 1, wherein the gate drive circuit is further configured to detect a further measured value of at least one further electrical cable quantity at the at least one detection time point, and to identify the at least one cable parameter of the cable from the least one measured value, the at least one further measured value and the identification gate quantity value.

7. The assembly according to claim 1, wherein the gate drive circuit is further configured to compare a value of the at least one cable parameter to a pre-defined reference cable parameter value in order to diagnose the cable.

8. The assembly according to claim 1, wherein the gate drive circuit is further configured to stop the inverter in case a deviation of the value of the at least one cable parameter from the pre-defined reference cable parameter value exceeds or falls below a pre-defined deviation threshold.

9. The assembly according to claim 1, wherein the gate drive circuit is further configured to identify the at least on least one cable parameter before a start of operation of the inverter.

10. The assembly according to claim 1, wherein the gate drive circuit is further configured to identify the at least on least one cable parameter during operation of the inverter.

11. The assembly according to claim 10, wherein the gate drive circuit is further configured to, at an adjustment time point during operation of the inverter after the identification time point, adjust the maximum gate quantity value to an adjusted maximum gate quantity value based on the at least one identified cable parameter, to further alternate the electrical gate quantity between the adjusted maximum gate quantity value and the minimum gate quantity value to switch the semiconductor switch.

12. The assembly according to claim 11, wherein the maximum gate quantity value is pre-set before a start of operation of the inverter and adjusted to the adjusted maximum gate quantity value based on the at least one identified cable parameter during operation of the inverter at the adjustment time point.

13. The assembly according to claim 1, wherein the gate drive circuit is configured to switch the semiconductor switch and is configured to detect or measure the at least one measured value of the at least one electrical cable quantity.

14. A method for identifying a motor cable in an electrical motor assembly comprising an inverter and a cable, the inverter having at least one semiconductor switch and a gate drive circuit, the gate drive circuit being configured to drive, in an alternating fashion, an electrical gate quantity present at a gate electrode of the semiconductor switch of the inverter between a maximum gate quantity value and a minimum gate quantity value to switch the semiconductor switch in order to connect and/or disconnect a supply voltage to an output of the inverter for electrically supplying a load connected to the output through the cable, comprising:
at an excitation time point, setting the electrical gate quantity to an identification gate quantity value generating an identification output voltage on the output of the inverter to be fed to the cable;
at an at least one detection time point after the excitation time point, measuring at least one measured value of at least one electrical cable quantity; and
at an identification time point after the detection time point, identifying at least one cable parameter of the cable from the least one measured value and the identification gate quantity value.

15. The assembly according to claim 3, wherein the excitation time points are consecutive.
